(19) United States
(12) Patent Application Publication
(10) Pub. No.: US 2013/0163797 A1
(43) Pub. Date: Jun. 27, 2013

(54) Systems and Methods for Diagnosis and Treating Tinnitus

(71) Applicants: Peter Suzman, Newton, MA (US); Gottfried Schlaug, Belmont, MA (US); Suzanne Priebatsch, Boston, MA (US)

(72) Inventors: Peter Suzman, Newton, MA (US); Norman Ernst Priebatsch, Boston, MA (US); Gottfried Schlaug, Belmont, MA (US)

(73) Assignee: Tinnix, Inc., Newton, MA (US)

(21) Appl. No.: 13/529,329

(22) Filed: Jun. 21, 2012

Related U.S. Application Data
(60) Provisional application No. 61/499,429, filed on Jun. 21, 2011.
(60) Provisional application No. 61/548,880, filed on Oct. 19, 2011.

(51) Int. Cl. H04R 25/00

(52) U.S. Cl. CPC H04R 25/50
USPC 381/314

(57) ABSTRACT

Systems and methods for diagnosis or treating tinnitus are disclosed. In some embodiments, a method for treating tinnitus includes receiving, by a programmed computer system, input data representative of one or more of the following characteristics of an user tinnitus: central frequency, bandwidth, volume, hearing threshold, and tone to noise ratio of a user tinnitus; processing, in real-time, by the programmed computer system, user tinnitus data to generate a user tinnitus profile based on the received one or more categories of user tinnitus data; and generating, in real-time, by the programmed computer system, a notched audio output according to the user tinnitus profile.

### RELATED APPLICATIONS

This application claims the benefit of and the priority to U.S. Provisional Application Ser. No. 61/499,429, entitled “SYSTEMS AND METHODS FOR TREATING TINNITUS,” filed on Jun. 21, 2011, and U.S. Provisional Application Ser. No. 61/548,880, entitled “SYSTEMS AND METHODS FOR TREATING TINNITUS,” filed on Oct. 19, 2011, and both of these applications are incorporated herein by reference in their entireties.

### FIELD

The embodiments disclosed herein relate to systems and methods for diagnosis and treating tinnitus, and more particularly to systems and methods for delivering notched audio output to tinnitus sufferers.

### BACKGROUND

Tinnitus is the perception of sound heard in the absence of external auditory stimulus. The causes of tinnitus are not well understood. Tinnitus often takes the form of hissing, ringing, or other sounds which may be either intermittent or constant. According to the American Tinnitus Association, tinnitus affects tens of millions of Americans and some suffer so severely from tinnitus they are not able to function normally on a daily basis.

### SUMMARY

Systems and methods for determining hearing thresholds including frequency ranges of hearing impairment and acoustic properties of the tinnitus and treating tinnitus are disclosed herein.

According to aspects illustrated herein, there is provided a method for treating tinnitus that includes receiving, by a programmed computer system, input data representative of one or more of the following characteristics of an user tinnitus: central frequency, bandwidth, volume, hearing threshold, and tone to noise ratio of a user tinnitus; processing, in real-time, by the programmed computer system, user tinnitus data to generate a user tinnitus profile based on the received one or more categories of user tinnitus data; and generating, in real-time, by the programmed computer system, a notched audio output according to the user tinnitus profile.

According to aspects illustrated herein, there is provided a computing device for treating tinnitus that includes a non-transient memory having at least one region for storing computer executable program code; and at least one processor programmed to execute the program code stored in the non-transient memory, wherein the program code comprises: code to receive input data representative of one or more of the following characteristics of an user tinnitus: central frequency, bandwidth, volume, and tone to noise ratio of a user tinnitus; code to process, in real-time, user tinnitus data to generate a user tinnitus profile based on the received one or more categories of user tinnitus data; and code to generate, in real-time, a notched audio output according to the user tinnitus profile.

According to aspects illustrated herein, there is provided a computer-readable medium that includes computer instructions, which when executed, carry out a method for treating tinnitus that includes receiving, by a programmed computer system, input data representative of one or more of the following characteristics of an user tinnitus: central frequency, bandwidth, volume, and tone to noise ratio of a user tinnitus; processing, in real-time, by the programmed computer system, user tinnitus data to generate a user tinnitus profile based on the received one or more categories of user tinnitus data; and generating, in real-time, by the programmed computer system, a notched audio output according to the user tinnitus profile.

### BRIEF DESCRIPTION OF THE DRAWINGS

The presently disclosed embodiments will be further explained with reference to the attached drawings, wherein like structures are referred to by like numerals throughout the several views. The drawings shown are not necessarily to scale, with emphasis instead generally being placed upon illustrating the principles of the presently disclosed embodiments.

FIG. 1 is a flowchart depicting an embodiment method for treating tinnitus of the present disclosure.

FIG. 2 is a flowchart depicting an embodiment method for treating tinnitus using a hearing aid device of the present disclosure.

FIG. 3A and FIG. 3B show one embodiment of a method for determining a hearing threshold of the user.

FIGS. 4A-4D show one embodiment of a method for determining the characteristics of the user's tinnitus sound.

FIG. 5A and FIG. 5B show one embodiment of presenting historic data collected from the user.

FIG. 6 is a block diagram of an embodiment system suitable for operation of the method for treating tinnitus of the present disclosure.

FIG. 7 is a block diagram of another embodiment system suitable for operation of the method for treating tinnitus using a hearing aid device of the present disclosure.

FIG. 8 is a block diagram of a computer processing device suitable for use as part of embodiment systems of the present disclosure illustrated in FIG. 6 and FIG. 7.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The embodiments disclosed herein relate to systems and methods for treating conditions and disorders affecting hearing or the ear. In particular, the embodiments disclosed herein relate to systems and methods for treating tinnitus. It should be noted however that although the methods and systems of the present disclosure are described herein in regard to treating of tinnitus, these methods and systems can also be utilized to treat other conditions, diseases and disorders affecting hearing, the ear or both.

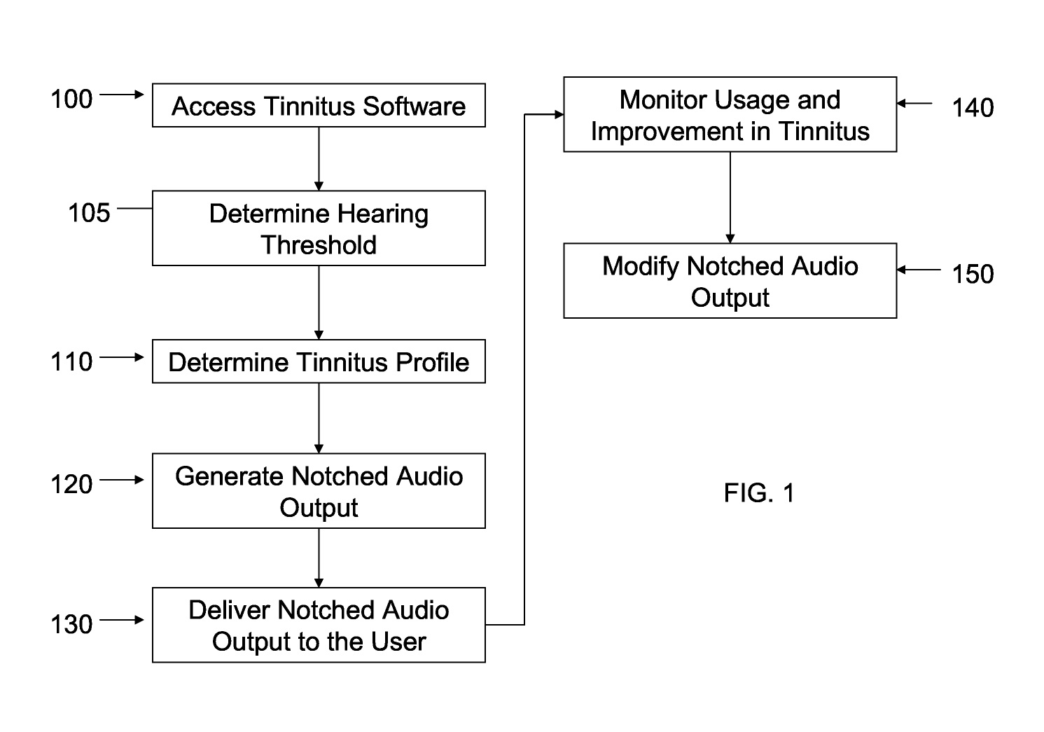

FIG. 1 shows a flowchart diagram that depicts an embodiment method for treating tinnitus. It is understood that at least one aspect/functionality of the various steps and embodiments described herein can be performed in real-time (or “in real time”) and/or dynamically. As used herein, the term “real-time”/“in real time” means that an event/action occurs instantaneously or almost instantaneously in time when another event/action has occurred. As used herein, the term “dynamic(ly)” means that an event/action occurs without any human intervention.

In step 100, the user accesses tinnitus measurement software to receive assistance in determining at least one characteristic of the user's tinnitus. In some embodiments, the tinnitus software can help the user determine one or more dominant frequencies of the user's tinnitus. In addition to the dominant frequency of the user's tinnitus, the tinnitus software can help determine the intensity, bandwidth, volume, tone to noise ratio, time-based variability or combinations thereof of the user's tinnitus, which can then be used for monitoring purposes, statistical analysis of the outcomes, or both. In addition, by using the microphone of the application, the current background noise level of the location can be assessed and optimal environmental condition with regard to background noise level can either be taken into account in the analysis or the software can suggest to seek a different environment with less background noise for the testing.

For the therapeutic treatment the band or bands of the tinnitus sounds are incorporated into a software application. The tinnitus measurement software can be installed on the user's mobile electronic device, such as a smart phone, a hearing aid device, a Bluetooth headphone or any other programmable headphone, or any other wearable and wireless device or product that could affect hearing. In some embodiments, the software may be located on a server that the user can access remotely, such as via the Internet. In some embodiments, the tinnitus software can assist the user in measuring one or more characteristics of the user's tinnitus as perceived separately from either ear. In some embodiments, the tinnitus software can also be used to keep data, record frequency of usage, store user-related data, provide advice regarding treatment protocols, etc.

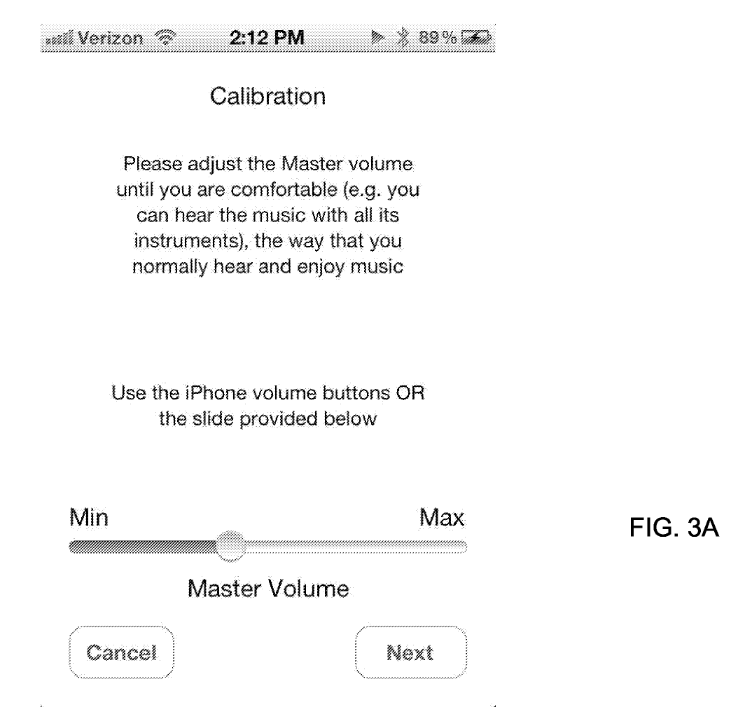

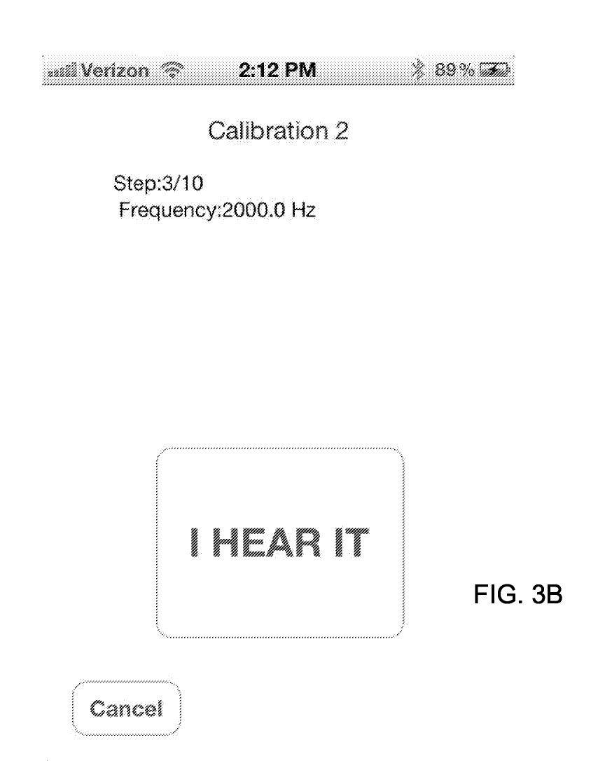

In some embodiments, a calibration process is performed in step 105 to establish a baseline for the user's hearing sensitivity or threshold across different frequencies in the spectrum. This helps to identify bands and/or regions where the user's hearing is different than the average and serves as reference for the modeling of the user's tinnitus tone and noise. FIG. 3A and FIG. 3B illustrate one non-limiting example of a calibration process. As illustrated in FIG. 3A, the user is first prompted to adjust the volume to a volume suitable for the user to hear and enjoy music. This step allows the user to make sure that the device is working properly, and also sets a benchmark for the hearing threshold of the user. Next, successive audio outputs of increasing amplitude at one or more pre-selected frequencies that span the hearing range are played and the user is asked to note at what amplitude at each frequency the user can first hear the audio output, as shown in FIG. 3B. The information gathered during the calibration process may be used, in some embodiments, to establish the hearing threshold of the user. Additionally or alternatively, this information may also be used in combination with the information about the user tinnitus collected in step 110. In some embodiments, if it is determined that the user already does not hear sound at a frequency that overlaps with the central frequency of the user's tinnitus due to hearing loss, the frequency that the user cannot hear will not need to be notched from the notched audio output, as is discussed below. In some embodiments, the amplitude of the sound in the matching process of step 110 may be boosted to compensate for any hearing loss found in the calibration process to generate a more accurate profile of the user's tinnitus.

Next, in step 110, the profile of the user's tinnitus is determined with the tinnitus software. To measure at least one characteristic of the user's tinnitus, the user is subjected to an audiometric test according to a standard procedure. For example, the user may be exposed to a sound in narrow frequency bands in the 100 Hz to 15 kHz range, with bandwidth varying between pure tone and 20% of frequency. The user can match his or her tinnitus sound using a 2-dimensional touch-sensitive input mechanism, with frequency on the X axis and bandwidth on the Y axis. In some embodiments, the process is as follows: a) user determines a comfortable volume level; b) user matches the user's tinnitus sound using the 2-dimensional touch-sensitive input mechanism; c) matching is repeated, with axes and/or slope of change modified; d) if match is reliable (i.e., within a pre-determined range of previous matching), move to next step, otherwise repeat step c; e) once a match is determined, user matches volume of sound to volume of tinnitus; f) volume match is repeated, with axes and/or slope of change modified and g) if volume match is reliable (i.e., within a pre-determined range of previous matching), process is completed, otherwise step f is repeated. In some embodiments, a predetermined range is set to about 6 dB or less difference in level and about ⅛ of octave for pitch.

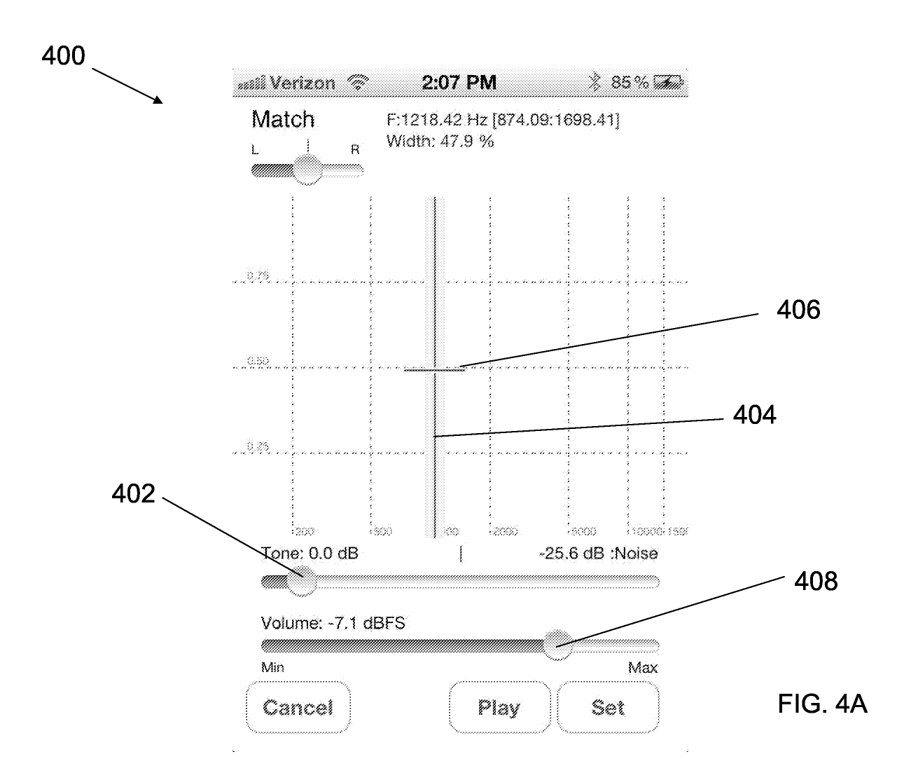

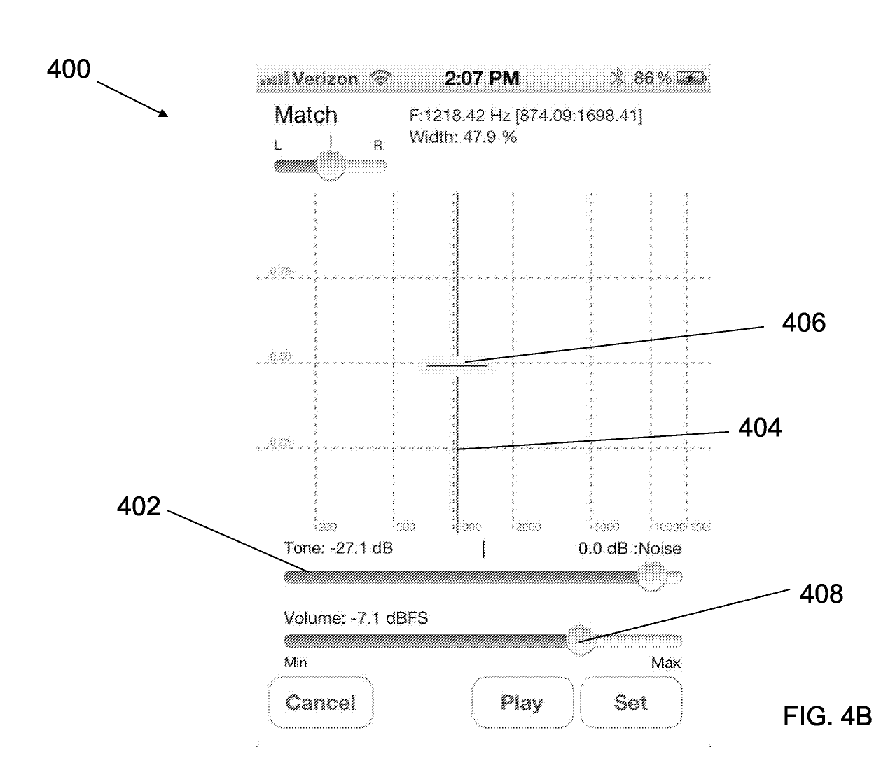

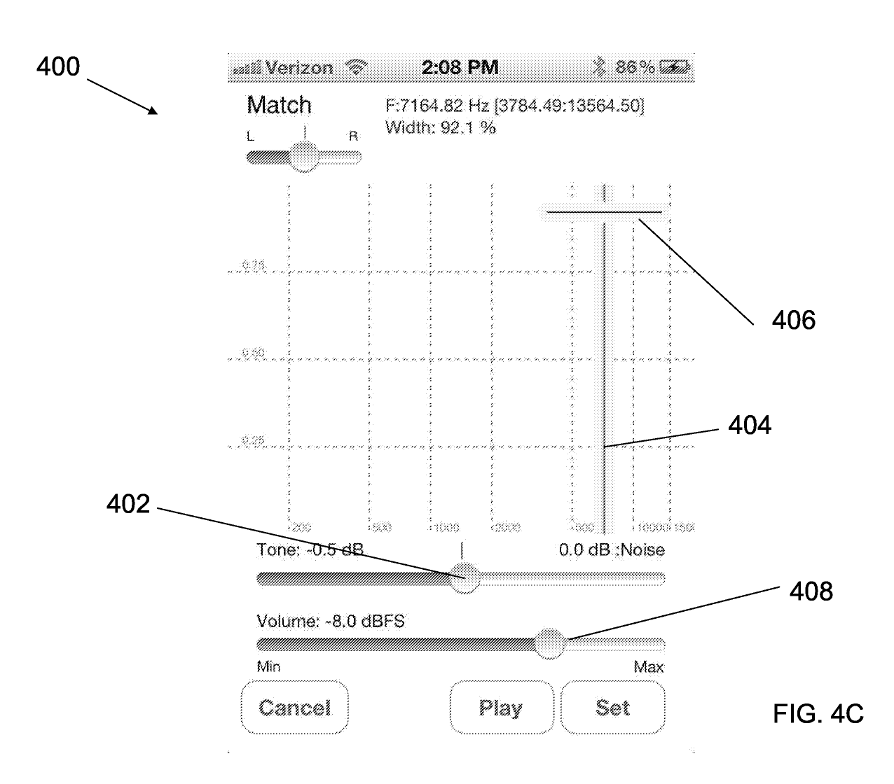

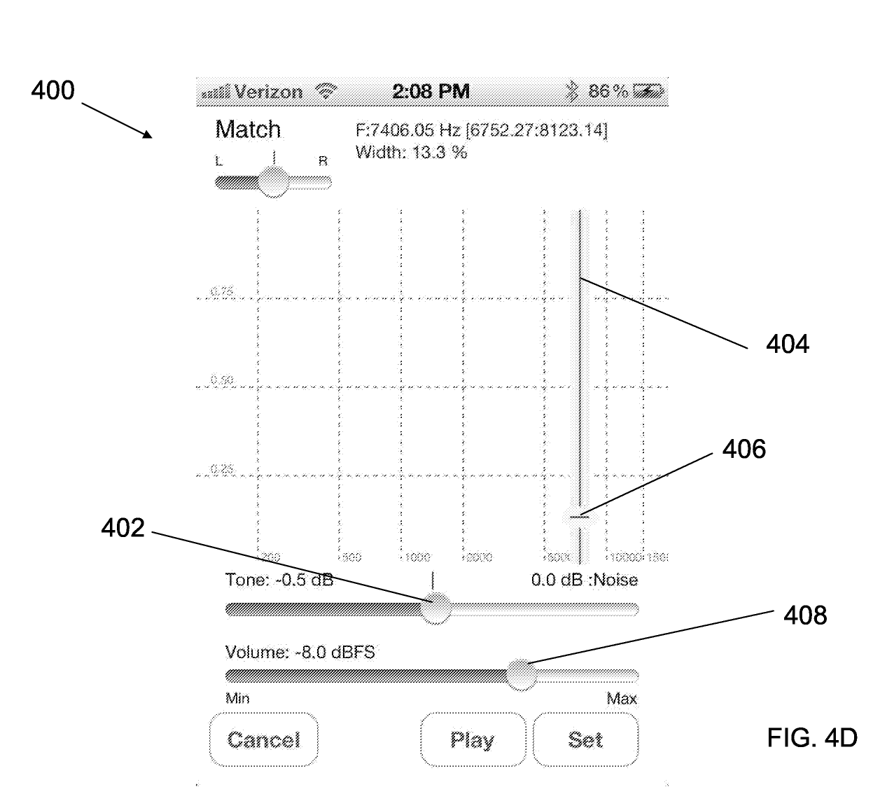

In some embodiments, the method of the present disclosure allows the user to determine the characteristics of the user's tinnitus sound. In some embodiments, the user may be provided with a touch-sensitive XY grid interface 400, as shown in FIGS. 4A-4D. The interface includes a number of widgets changeable by the user, such as, a widget 402 representative of tone to noise ratio, widget 404 representative of central frequency, widget 406 representative of bandwidth, and widget 408 representative of volume. After the program is activated by pressing the “play” button 410, the tinnitus software generates and plays an audio output and the user is allowed to manipulate one or more characteristics of the audio output the widgets of the touch-sensitive XY grid interface 400 to match the one or more characteristics of the audio output to a corresponding characteristic of the user tinnitus. In some embodiments, the user can use the “tone/noise” widget 402 to select if the user's tinnitus is more tone like (i.e. a continuos beep sound) or noise like (more like background static noise). Next, the user can move the vertical line 404 indicative of central frequency and horizontal line 406 indicative of bandwidth to change the frequency and bandwidth of the sound, where the horizontal movements along the X-axis change the frequency (low on the left, high on the right) of the sound and the vertical movements along the Y-axis affect the bandwidth of the noise. This may have no effect if only tone has been selected, except that the bandwidth is approximately equal to the width of the vertical bar. Subsequently, the user matches the intensity of the tinnitus sound using the “volume” widget 408, and also set the audio output at a comfortable level for the test. The above steps can be repeated until a satisfactory match for the user's tinnitus is found. The results of the tests can be saved, and the test may be repeated to ensure reproducibility of the result. In some embodiments, the grid descriptors and other coordinate information can be removed and the positions on the screen can be different to remove any bias in subsequent test runs.

When the test is complete, the tinnutis software determines the characteristics of the user tinnutis based on the final state of the one or more widgets 402, 404, 406, 408 representative of tone to noise ratio, frequency, bandwidth, and volume, respectively, to be used in generating profile of the user tinnutis. In some embodiments, the information regarding one or more of tone to noise ratio, frequency, bandwidth, and volume of the user tinnutis is displayed on the screen for the user's review. Alternatively or additionally, this information can be presented visually by changing the width, length or both of the horizontal and vertical bars. For example, in reference to FIG. 4A and FIG. 4B, the relative width of the horizontal bar (noise) and the vertical bar (tone) changes as the ratio of tone to noise is changed. In another example, as shown in FIG. 4C and FIG. 4D, moving the horizontal bar down decreases the bandwidth of the noise component of the tinnitus, while moving the vertical bar changes the frequency of the tone and of the central frequency of the noise.

The bandwidth or frequency span of the user's tinnitus is an important determinant of its shape. If the user hears a nearly pure tone the bandwidth is narrow. If the user hears a scratchy noise the band width may be broader. The bandwidth may also depend on the central frequency. If the tinnitus is at a low frequency, say 1000 Hz, the bandwidth could be as narrow as 100 Hz. If the tinnitus centers on a higher frequency, say 6,000 Hz, the bandwidth may be a 1,000 Hz wide.

By way of a non-limiting example of a matching process, a user determines that best match for the user's condition is 5,000 Hz with a bandwidth of 200 Hz in trial 1 and 4,800 Hz with a bandwidth of 190 Hz in trial 2. If trial 1 and trial 2 are deemed to match within a predetermined threshold, the user's tinnitus dominant frequency is determined to be their mean. Using this newly determined dominant frequency, the user can determine tinnitus level on first trial at 20% of device maximum volume. On second volume trial, the user can match to 25% of device maximum volume. Because two volume trials are within threshold, the volume is determined to be the average of 20% and 25%.

By way of a non-limiting example of a matching process, a user determines that best match for the user's condition is 5,000 Hz with a bandwidth of 200 Hz in trial 1 and 4,200 Hz with a bandwidth of 190 Hz in trial 2. If trial 1 and trial 2 are deemed to not yet match within a predetermined threshold, additional trials may be required. In some embodiments, during trial 3, the user's best match is 4,800 Hz with a bandwidth of 205 Hz. If variance of multiple trials is deemed to be below a predetermined threshold, then the tinnitus dominant frequency is determined to be the mean. In some embodiments, however, the tinnitus dominant frequency is determined to be the median, if there is an outlier, or the test may be repeated, or the median may be deemed not determinable and therefore treatment will not be available. Using this newly determined dominant frequency, the user can determine the user's tinnitus level on first trial at 20% of device maximum volume. On second volume trial, the user matches to 25% of device maximum volume. Accordingly, if two volume trials are within threshold, so volume is determined to be average of 20% and 25%.

In order to allow the user to measure the characteristics of their tinnitus, the tinnitus software includes a “blinded” input method so that new trials are not influenced by previous results. In some embodiments, to provide a “blinded” input method, characteristics of the interface widget may be altered among successive tests, including, but not limited, to the position, type, mode of operation, and representation of various widgets.

In some embodiments, this diagnostic input procedure uses a pointing device such as a computer mouse or finger on a touch screen. For each measurement the user can match at least one characteristic of his or her tinnitus, such as frequency or intensity or other characteristics, to a sound provided to the user, with characteristics controlled by the user's pointing device. However, in successive trials the positioning of the user's pointing device on the screen will change with respect to a given frequency and intensity of sound, and the rate of change of frequency, quality or intensity with changes in pointing input can also change. This will provide a blinding to the user, removing bias, in performing multiple matching and periodic future evaluations.

In some embodiments, the user can indicate a best-match to at least one characteristic of his or her tinnitus by means of a two dimensional input, where one dimension corresponds to the dominant frequency of the tinnitus and the other dimension corresponds to some other characteristic of the tinnitus, such as frequency spread or time-based modulation (still tonal tinnitus, but that increases or decreases in level over time in a repetitive fashion). As before repeated trials will be “blinded” in that the same match corresponds to different locations of the pointing device on the screen. It will of course be understood that, in some embodiments, the tinnitus software may allow the user to enter his or her previously-determined tinnitus profile, as to skip step 110. In some embodiments, the tinnitus software may present the user with a questionnaire about the user hearing, characteristics of the user's tinnitus or both.

In step 120, customized notched audio output can be generated based on the information collected in step 105, step 110 or both. For the purpose of the present disclosure, the term “notched audio output” refers to an audio output having a silent window of a pre-selected width or amplitude centered at the dominant frequency of the user's tinnitus. In other words, audio output can be “notched” by removing all sound in the frequency band or bands surrounding the dominant frequency of the user's tinnitus. In some embodiments, the preselected frequency band or amplitude is between half an octave above and half an octave below the dominant frequency, although a narrower or wider range for this notching can be set. In some embodiments, the audio output is notched to remove a one octave range around the dominant frequency of the user's tinnitus.

In some embodiments, the audio output may be modified by using a band-stop filter which filters out or removes a range of frequencies from the audio output, or other filtering criteria that could remove/enhance regions of audio according to the suggested medical treatment. In some embodiments, the software algorithm silences sound by not amplifying in the range. Duration is at the choice of the user and recommendation based on clinical trial findings.

In some embodiments, the user is provided with a choice of audio outputs, including, but not limited, to the type of music and the source of music, such as, locally stored or streamed. In some embodiments, the notched audio output may be prepared in the form of random noise, such as white noise that may be modified by allowing the user to increase or decrease the amplitude in different frequency ranges using a graphical interface so as to achieve an optimal masking effect and/or is additionally modified so as to boost its amplitude in frequencies that have overtones close to the dominant frequency of the tinnitus.

Next, the notched audio output can be delivered to the user in step 130. In some embodiments, the user may listen to the supplied notched audio output for a duration and with regularity per a selected treatment protocol. As noted above, the notched audio output can be in the form of music that can be played through a headset (earbuds or headphones) or speakers.

In some embodiments, the user may access the tinnitus software to test whether there are any changes in the user's condition at any time during treatment, as shown in step 140. The process described above in connection with step 110 can be employed to monitor changes in the profile of the user's tinnitus. In some embodiments, upon completion of the selected treatment protocol, or if no improvements are noted in due course or if the tinnitus profile has changed per step 140, the user may again utilize the tinnitus software to generate a new notched audio output based on the user's current condition, as represented by step 150.

In another aspect, a method for treating tinnitus includes listening to sounds which have naturally occurring overtones within half an octave of the dominant frequency of the tinnitus, but where these overtones are filtered out. For example, if the dominant frequency of the user's tinnitus is determined to be 4,800 Hz, the instant method includes listening to a musical note with a central frequency of 1,200 Hz and having overtones at 2,400 Hz, 4,800 Hz and 9,600 Hz, where the 4,800 Hz overtone is filtered out. In some embodiments, where the tinnitus has a sufficiently narrow dominant frequency range, such as, for example, between about 4,000 HZ to about 4,800 Hz, the instant method includes listening to a musical note that starts at approximately 1,000 Hz and slowly rises in frequency to 1,200 Hz, where all overtones in the range of about 4,000 to about 4,800 HZ are filtered out. In some embodiments, the instant method includes a step of listening to music where all notes that have overtones within a certain range (such as ¼ of an octave) of the dominant frequency of the user's tinnitus are boosted (by, for example, 10-20 db) together with all their overtones, except for the overtones that are within the specified range of the tinnitus, which are filtered out.

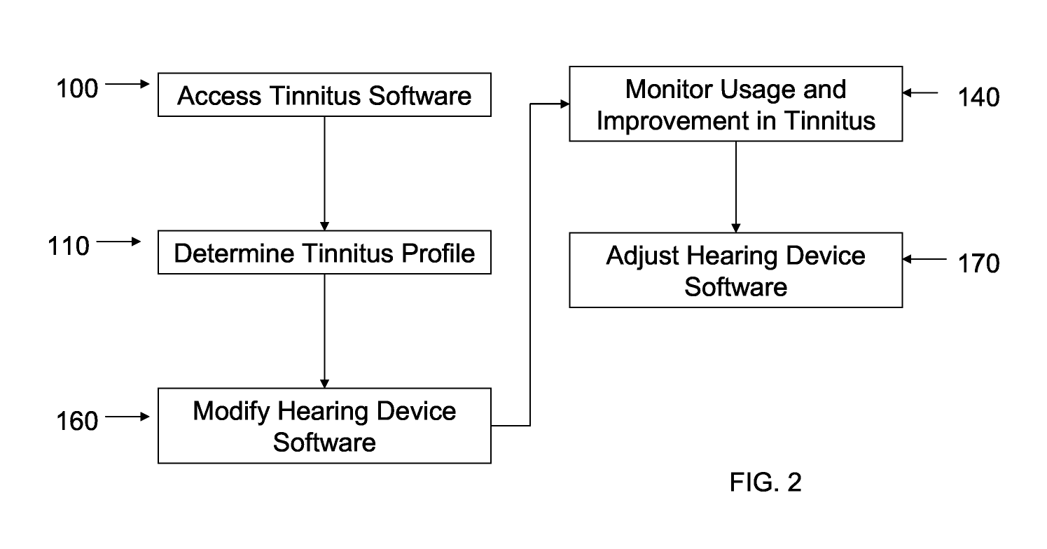

The present disclosure also provides a method for treating tinnitus using a hearing device which can be a programmable hearing aid, a Bluetooth headphone or any other programmable headphone, or any other wearable and wireless device or product that could affect hearing. In some embodiments, a programmable hearing device may be utilized. The hearing device is preferably of the form that attenuates sounds in the environment in the absence of amplification. In reference to FIG. 2, such method for treating tinnitus includes the step 110 of accessing a software capable of, among other things, determining the central frequency of the user's tinnitus and the step 110 of using such software. Alternatively or additionally, the characteristics of the user's tinnitus can be determined by an audiologist or other similar means such as using the diagnostic software built into the application.

Next, if desired by the user, the hearing aid software may be modified in step 160, using the characteristic of user's tinnitus determined in step 110. In some embodiments, the hearing aid software may be modified to substantially reduce the transmission of sound in a frequency range surrounding the central frequency. The frequency range will vary. In some embodiments, the notching or non-amplification of sound is custom to the user.

In some embodiments, the hearing aid software or a Bluetooth headphone or any other programmable headphone, or any other wearable and wireless device or product that could affect hearing may be modified to amplify any sounds that have overtones close to the dominant frequency of the tinnitus. In some embodiments, the hearing aid software may be modified such that, absent amplification, the hearing aid attenuates sounds in the notched frequency by at least about 10 db. In some embodiments, when the modified software is activated, all sound the user hears is notched in the range of the dominant frequency of the user's tinnitus.

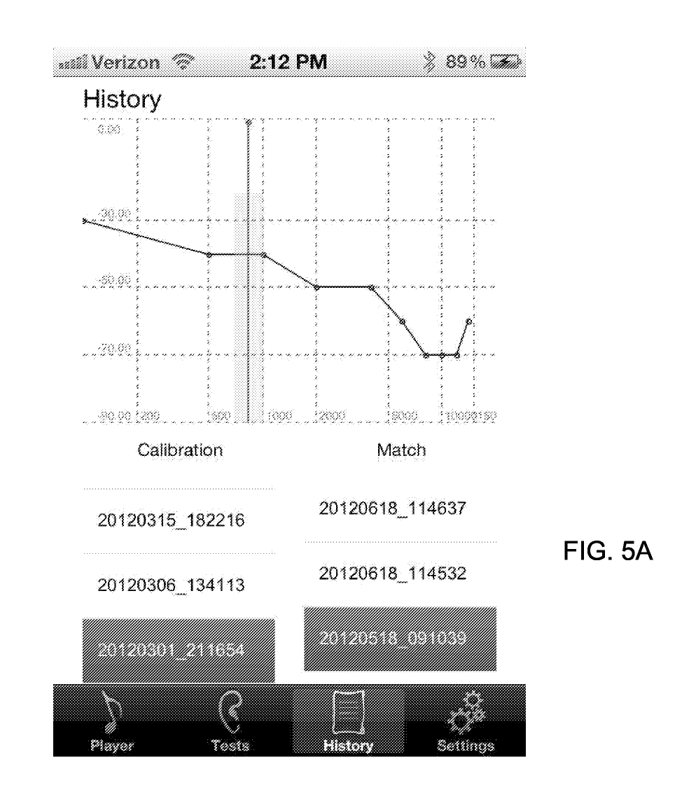

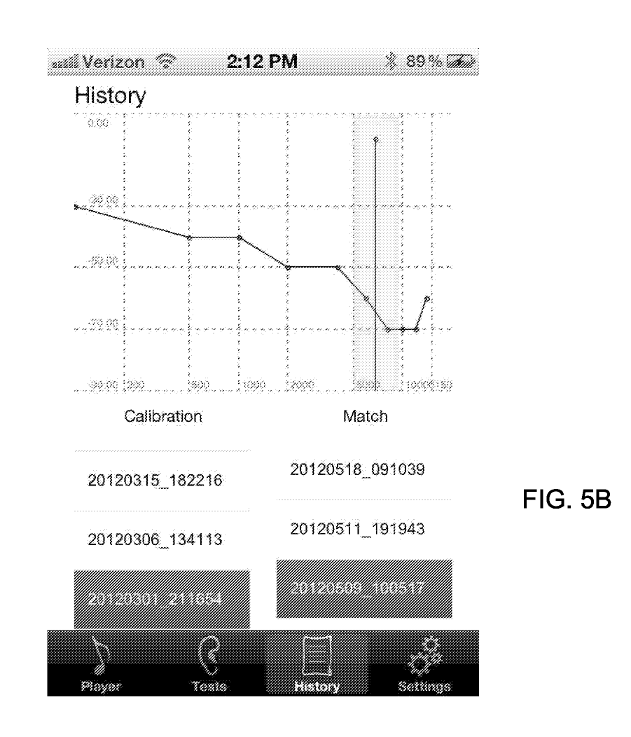

In some embodiments, after using the modified hearing aid for a time sufficient to determine whether the modifications in step 160 have had any effect on the user's tinnitus, the user may access the tinnitus software to test whether there are any changes in the user's condition at any time during treatment, as shown in step 140. The process described above in connection with step 105 and step 110 can be employed to monitor changes in the profile of the user's tinnitus. In some embodiments, the tinnitus software may present the user with the history of information collected in step 105 and step 110, as shown in FIG. 5A and FIG. 5B, which may be useful to assist the user in tracking the user's treatment progress. In some embodiments, upon completion of the selected treatment protocol, or if no improvements are noted in due course or if the tinnitus profile has changed per step 140, the user may again utilize the tinnitus software to further adjust the hearing aid software, as represented by step 170.

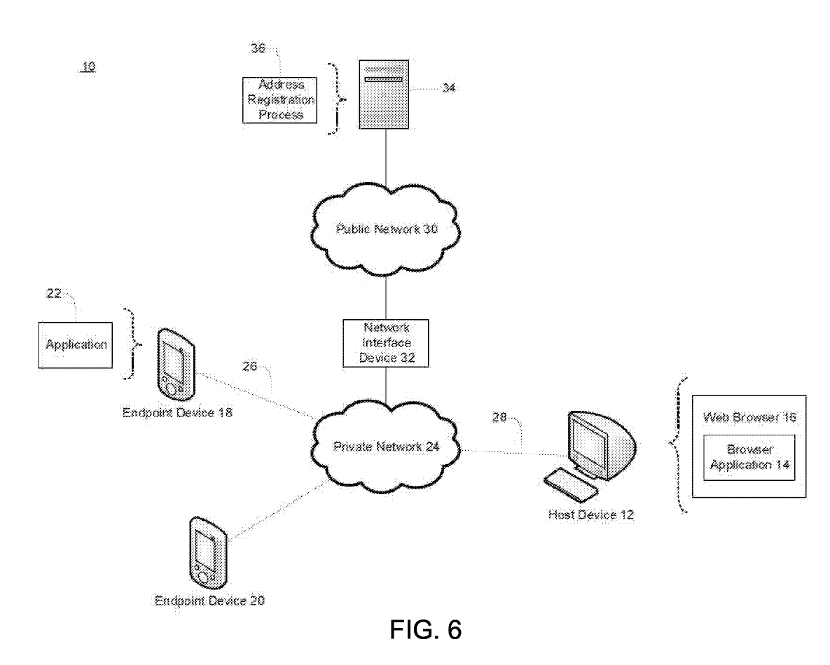

In another aspect, a system 10 for treating tinnitus is provided. FIG. 6 illustrates one embodiment of an environment in which the system 10 may operate. However, not all components illustrated in FIG. 6 may be required to practice the embodiments of the present disclosure, and variations in the arrangement and type of the components may be made without departing from the spirit or scope of the present disclosure. In some embodiments, the instant invention can host a large number of persons and concurrent transactions. In other embodiments, the instant invention can be based on a scalable computer and network architecture that incorporates various strategies for assessing the data, caching, searching, and database connection pooling. An example of the scalable architecture is an architecture that is capable of operating multiple servers.

In reference to FIG. 6, in some embodiments, the system 10 may include a host device 12 capable of executing software applications and processes, such as, by way of non-limiting example, the tinnitus software. In some embodiments, the tinnitus software may be located locally on the host device 12 or on a remote server 34 to which the host device may connect via a network. The tinnitus software may be executed within web browser 16 or directly on the host device 12.

FIG. 6 shows host device 12 as a desktop computer, however host device 12 is not limited to desktop computers. For example, host device 12 may be a laptop computer, server computer, game console, personal electronic device, mobile electronic device, such as for example, a smart phone, personal digital assistant or similar handheld device, internet television, home appliance, network- and processor-enabled remote control toy, internet enabled billboard, medical display device, iPad®, iPhone®, BlackBerry® or any other device capable of running software applications and processes, such as tinnitus software. In some embodiments, the host device may also include applications for generating notched audio output, such as notched music, which can then be streamed to the user's endpoint device.

The system 10 may also include one or more endpoint devices 18, 20 which may be utilized by the user to communicate with the tinnitus software 14, either on the host device 12 or remote server 34. Endpoint devices 18, 20 may typically be a network-enabled wireless handheld device, such as a PDA or smart phone, which can run an application 22. However, the endpoint devices 18, 20 may also be any type of device capable of running application 22 and connecting to the host device 12, such as a laptop or desktop computer, a gaming console, a game controller, etc. In some embodiments, the endpoint devices 18, 20 may also be capable of generating and/or playing the notched audio output generated by the tinnitus software.

In some embodiments, the host device 12 and/or endpoint devices 18, 20 can include a browser application that is configured to receive and to send web pages, and the like. In embodiments, the browser application is configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In some embodiments, the host device 12 and/or endpoint devices 18, 20 can be programmed in either Java or .Net.

The host device 12, remote server 34 and/or endpoint devices 18, 20 may be connected to a private or public network to enable them to receive and send a message over the network to and from one another or other computing devices. In some embodiments, the host device 12 can connect to the remote server via a public network 30 and to the endpoint devices via a private network 24. The network can typically be the Internet, a local area network (LAN), a wide area network (WAN) or other types of networks, including but not limited to, a Bluetooth® network, a USB network, direct connections, such as through a universal serial bus (USB) port, other forms of computer-readable media, or any combination thereof. In embodiments, on an interconnected set of LANs, including those based on differing architectures and protocols, a router acts as a link between LANs, enabling messages to be sent from one to another. Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, in embodiments, remote computers and other related electronic devices could be remotely connected to either LANs or WANs via a modem and temporary telephone link. In essence, in embodiments, networks 24, 30 can include any communication method by which information may travel between computing devices. Connections 26, 28 may be wired or wireless connections and may employ any appropriate communication technologies and protocols to enable communication between the devices.

The system 10 may further include a network interface device 32. The interface device may provide a bridge between private network 24 and public network 30, and also may provide a security barrier between private network 24 and the internet, such as a firewall. Typical examples of network interface device 32 are cable modems, DSL modems, T1 connections, and the like. Devices connected to public network 30 (i.e. the internet) typically cannot penetrate the security barrier of network interface device 32 to discover or communicate with devices on private network 32. However, In some embodiments, network interface device 32 may allow devices on private network 24 to access public network 30 so that they can browse the internet, download applications, and communicate with devices on the internet. Network interface device 32 may be a single network interface device, or may be multiple network interface devices that provide multiple access points between private network 24 and the internet.

In some embodiments, the devices of the system 10 can utilize NFC technology to obtain/transmit information. In some embodiments, NFC can represent a short-range wireless communications technology in which NFC-enabled devices are “swiped,” “bumped,” “tapped” or otherwise moved in close proximity to communicate. In some embodiments, NFC could include a set of short-range wireless technologies, typically requiring a distance of 10 cm or less. In some embodiment, NFC can operates at 13.56 MHz on ISO/IEC 18000-3 air interface and at rates ranging from 106 kbit/s to 424 kbit/s. In some embodiments, NFC can involve an initiator and a target; the initiator actively generates an RF field that can power a passive target. In some embodiment, this can enable NFC targets to take very simple form factors such as tags, stickers, key fobs, or cards that do not require batteries. In some embodiments, NFC peer-to-peer communication can be conducted when a plurality of NFC-enable device within close proximity of each other.

In some embodiments, NFC tags can contain data and be read-only or rewriteable. In some embodiment, NFC tags can be custom-encoded. In some embodiments, NFC tags and/or NFC-enabled device (e.g., smart phones with NFC capabilities) can securely store personal data such as debit and credit card information, loyalty program data, PINS and networking contacts, and/or other information. NFC tags can be encoded to pass a Uniform Resource Locator (URL) and a processor of the NFC-enabled device can automatically direct a browser application thereof to the URL without prompting for permission to proceed to the designated location.

In some embodiments, data may also be communicated using any wireless means of communication, such as 4G, 3G, GSM, GPRS, WiFi, WiMax, and other remote local or remote wireless communication using information obtained via the interfacing of a wireless NFC enabled mobile device to another NFC enabled device or a NFC tag. In some embodiments, the term “wireless communications” includes communications conducted at ISO 14443 and ISO 18092 interfaces. In some embodiments, the communications between NFC-enabled smart device and lottery provided equipment (e.g., terminals, POS, POE, Hosts) is performed, for example, in accordance with the ISO 14443A/B standard and/or the ISO 18092 standard.

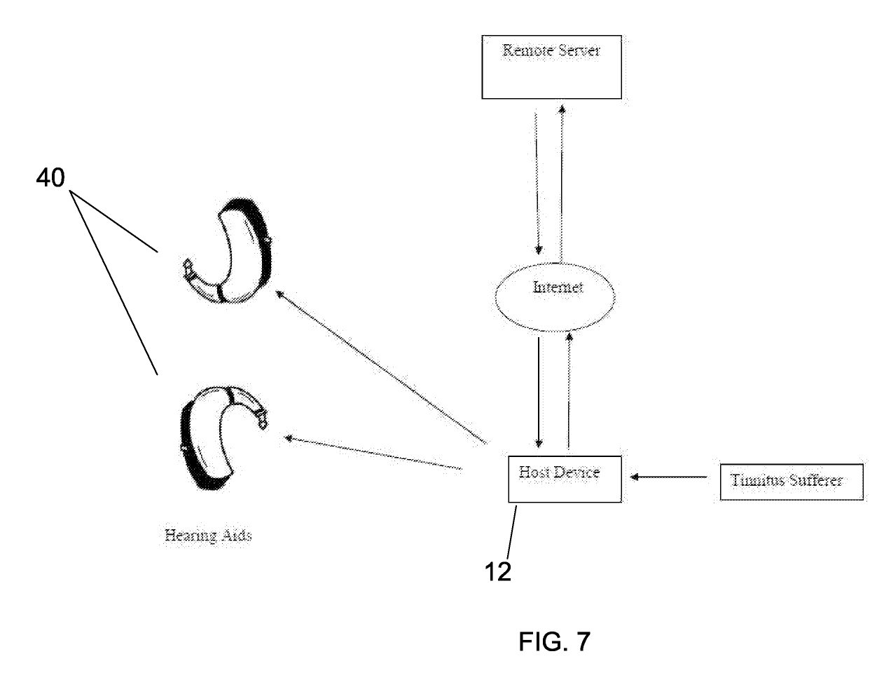

In reference to FIG. 7, in another embodiment, the system 10 may be used for modifying hearing aid software or a Bluetooth headphone or any other programmable headphone, or any other wearable and wireless device or product that could affect hearing. In such an embodiment, a programmable hearing aid device 40 may be connected to the host device 12 to enable the user to modify software in the hearing aid device for treating tinnitus, per method described above in connection with FIG. 2.

System 10 shows a typical configuration for the methods described herein. However, system 10 is not the only architecture within which the inventions described herein can operate. One skilled in the art will recognize that various system architectures can support the systems, methods, and apparatuses described herein. Also, although not shown, any of the applications and processes may be run by any computing device within system 10, or by any computing device capable of running the applications and processes. For example, in some embodiments, the tinnitus software may be stored and executed on one of the end devices 18, 20, in addition to or instead of storing and executing the tinnitus software 14 on the host device 12.

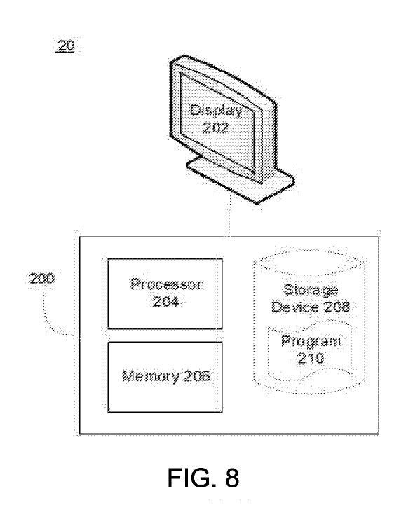

The methods for treating tinnitus disclosed herein may be implemented as hardware, software, or a combination of hardware and software. FIG. 8 shows a diagram of a typical processing architecture, which may execute software applications and processes. Computer processing device 200 is coupled to display 202 for graphical output. Processor 204 is a computer processor capable of executing software. Typical examples are computer processors (such as Intel® or AMD® processors), ASICs, microprocessors, and the like. Processor 204 is coupled to memory 206, which is typically a volatile RAM memory for storing instructions and data while processor 204 executes. Processor 204 may also be coupled to storage device 208, which is a non-volatile storage medium, such as a hard drive, FLASH drive, tape drive, DVDROM, or similar device. Although not shown, computer processing device 200 typically includes various forms of input and output. The I/O may include network adapters, USB adapters, Bluetooth radios, mice, keyboards, touchpads, displays, touch screens, LEDs, vibration devices, speakers, microphones, sensors, or any other input or output device for use with computer processing device 200. Processor 204 may also be coupled to other type of computer-readable media, including, but are not limited to, an electronic, optical, magnetic, or other storage or transmission device capable of providing a processor, such as the processor 204, with computer-readable instructions. Various other forms of computer-readable media can transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Program 210 is a computer program or computer readable code containing instructions and/or data, and is stored on storage device 208. The instructions may comprise code from any computer-programming language, including, for example, C, C++, C#, Visual Basic, Java, Python, Perl, and JavaScript. In a typical scenario, processor 204 may load some or all of the instructions and/or data of program 210 into memory 206 for execution. Program 210 can be any computer program or process including, but not limited to web browser 16, browser application 14, address registration process 36, application 22, or any other computer application or process. Program 210 may include various instructions and subroutines, which, when loaded into memory 206 and executed by processor 204 cause processor 204 to perform various operations, some or all of which may effectuate the methods for treating tinnitus disclosed herein. Program 204 may be stored on any type of non-transitory computer readable medium, such as, without limitation, hard drive, removable drive, CD, DVD or any other type of computer-readable media.

In some embodiments, a method for treating tinnitus includes the steps of: accessing a software capable of, among other things, determining at least one characteristic of the user's tinnitus, generating notched audio output based on the at least one characteristic of the user's tinnitus determined in the previous step, providing notched audio output to the user, and enabling the user to listen to the notched audio output per a pre-selected tinnitus treatment protocol.

In some embodiments, a system for treating tinnitus includes a host device capable of executing software application for determining at least one characteristic of the user's tinnitus, an endpoint device which may be utilized by the user to communicate with the software application on the host device, means for generating notched audio output, based on the at least one characteristic of the user's tinnitus and delivering the notched audio output to the endpoint device, so the user can listen to the notched audio output per a pre-selected treatment protocol.

In some embodiments, a method for treating tinnitus includes the steps of: accessing a software capable of, among other things, determining at least one characteristic of the user's tinnitus, generating notched music, based on the at least one characteristic of the user's tinnitus determined in the previous step, providing notched music to the user, and enabling the user to listen to the notched music per a pre-selected tinnitus treatment protocol.

In some embodiments, a method for treating tinnitus is disclosed that includes the steps of: determining characteristics of the user's tinnitus, such as the central frequency of the user's tinnitus, and using the characteristic thus determined, modifying the characteristics of the hearing aid or any other wireless Bluetooth, headphone or wearable device software at the option of the user so as to substantially reduce the transmission of sound in a frequency range surrounding the central frequency. In some embodiments, the characteristics of the user's tinnitus can be determined using a software of the present disclosure. Alternatively or additionally, the characteristics of the user's tinnitus can be determined by an audiologist or other similar means such as using the diagnostics built into the software application.

In some embodiments, a system for treating tinnitus using a hearing aid, a Bluetooth headphone or any other programmable headphone, or any other wearable and wireless device or product that could affect hearing is disclosed that includes a host device capable of executing software application for determining the central frequency of the user's tinnitus, and a programmable hearing aid or wireless, programmable headphone device that can be connected to the host device to modify software of the hearing aid or wireless headphone device to substantially reduce the transmission of sound in a frequency range surrounding the central frequency. The hearing aid or wireless headphone device is preferably of the form that attenuates sounds in the environment in the absence of amplification.

In some embodiments, a method for treating and masking tinnitus includes the steps of: accessing a software capable of, among other things, determining at least one characteristic of the user's tinnitus, generating notched and modified white or grey (or similar) noise based on the at least one characteristic of the user's tinnitus determined in the previous step, and providing such modified white or grey noise to the user, thus enabling both simultaneous masking and treatment of tinnitus. In this embodiment, the white, grey (or similar) noise is modified from traditional white or grey noise by ensuring that all audible overtones of each frequency present are included unless they are otherwise excluded by the notch.

In some embodiments, a method for treating tinnitus using a hearing aid includes the steps of: determining characteristics of the user's tinnitus, such as, the central frequency of the user's tinnitus, and using the characteristic thus determined, modifying the characteristics of the hearing aid software at the option of the user so as to substantially reduce the transmission of sound in a frequency range surrounding the central frequency.

In some embodiments, a system for treating tinnitus using a hearing aid is disclosed that includes a host device capable of executing software application for determining the central frequency of the user's tinnitus, and a programmable hearing aid device that can be connected to the host device to modify software of the hearing aid device to substantially reduce the transmission of sound in a frequency range surrounding the central frequency. The hearing aid device is preferably of the form that attenuates sounds in the environment in the absence of amplification.

In some embodiments, a method for treating tinnitus includes receiving, by a programmed computer system, input data representative of one or more of the following characteristics of an user tinnitus: central frequency, bandwidth, volume, hearing threshold, and tone to noise ratio of a user tinnitus; processing, in real-time, by the programmed computer system, user tinnitus data to generate a user tinnitus profile based on the received one or more categories of user tinnitus data; and generating, in real-time, by the programmed computer system, a notched audio output according to the user tinnitus profile.

In some embodiments, a computing device for treating tinnitus includes a non-transient memory having at least one region for storing computer executable program code; and at least one processor programmed to execute the program code stored in the non-transient memory, wherein the program code comprises: code to receive input data representative of one or more of the following characteristics of an user tinnitus: central frequency, bandwidth, volume, and tone to noise ratio of a user tinnitus; code to process, in real-time, user tinnitus data to generate a user tinnitus profile based on the received one or more categories of user tinnitus data; and code to generate, in real-time, a notched audio output according to the user tinnitus profile.

In some embodiments, a computer-readable medium includes computer instructions, which when executed, carry out a method for treating tinnitus that includes receiving, by a programmed computer system, input data representative of one or more of the following characteristics of an user tinnitus: central frequency, bandwidth, volume, and tone to noise ratio of a user tinnitus; processing, in real-time, by the programmed computer system, user tinnitus data to generate a user tinnitus profile based on the received one or more categories of user tinnitus data; and generating, in real-time, by the programmed computer system, a notched audio output according to the user tinnitus profile.

All patents, patent applications, and published references cited herein are hereby incorporated by reference in their entirety. While the methods of the present disclosure have been described in connection with the specific embodiments thereof, it will be understood that it is capable of further modification. Furthermore, this application is intended to cover any variations, uses, or adaptations of the methods of the present disclosure, including such departures from the present disclosure as come within known or customary practice in the art to which the methods of the present disclosure pertain, and as fall within the scope of the appended claims.

What is claimed is:

1. A method for treating tinnitus comprising:
receiving, by a programmed computer system, input data representative of one or more of characteristics of an user tinnitus: central frequency, bandwidth, volume, hearing threshold, and tone to noise ratio of a user tinnitus;
processing, in real-time, by the programmed computer system, user tinnitus data to generate a user tinnitus profile based on the received one or more categories of user tinnitus data; and
generating, in real-time, by the programmed computer system, a notched audio output according to the user tinnitus profile.

2. The method of claim 1 further comprising providing, in real time, by the programmed computer system, the notched audio output to the user.

3. The method of claim 1 wherein the step of generating comprises:
assessing, in real time, by the programmed computer system, a software of a hearing aid device; and
modifying, in real time, by the programmed computer system, the software of the hearing aid device according to the user tinnitus profile.

4. The method of claim 3 wherein the step of modifying comprises programming the hearing aid device to reduce the transmission of sound in a frequency range surrounding the central frequency of the user tinnitus.

5. The method of claim 1 wherein the step of receiving comprises:
presenting to a user an interface with one or more widgets changeable by the user, each widget being representative of one or more characteristics of the user tinnitus;
generating an audio output to the user;
allowing the user to manipulate the audio output by changing a state the one or more widgets to match at least one characteristic of the audio output to a corresponding characteristic of the user tinnitus; and
determining one or more characteristics of the user tinnitus from the state of the one or more widgets.

6. The method of claim 5 wherein each widget is representative of one of central frequency, bandwidth, volume, and tone to noise ratio of the user tinnitus.

7. The method of claim 1 wherein the step of receiving input date representative of the hearing threshold of the user comprises:
exposing the user to successive audio outputs of increasing amplitude at one or more pre-selected frequencies over a normal hearing range; and
receiving an indication from the user at what amplitude at each frequency the user first hears the audio output.

8. The method of claim 1 wherein the notched audio output is a random notched noise further modified to alter the amplitude in pre-selected remaining frequency ranges.

9. A computing device for treating tinnitus comprising:
a non-transient memory having at least one region for storing computer executable program code; and
at least one processor programmed to execute the program code stored in the non-transient memory, wherein the program code comprises:
code to receive input data representative of one or more of the following characteristics of an user tinnitus: central frequency, bandwidth, volume, and tone to noise ratio of a user tinnitus;
code to process, in real-time, user tinnitus data to generate a user tinnitus profile based on the received one or more categories of user tinnitus data; and
code to generate, in real-time, a notched audio output according to the user tinnitus profile.

10. The device of claim 9 further comprising code to deliver the notched audio output to the user.

11. The device of claim 9 wherein the code to generate the notched sound comprises:
code to assess, in real time, a software of a hearing aid device; and
code to modify, in real time, the software of the hearing aid device according to the user tinnitus profile.

12. The device of claim 11 wherein the code to modify comprises code to program the hearing aid device to reduce the transmission of sound in a frequency range surrounding the central frequency of the user tinnitus.

13. The device of claim 9 wherein the code to receive comprises:
code to present to a user an interface with one or more widgets changeable by the user, each widget being representative of one or more characteristics of the user tinnitus;
code to generate an audio output to the user;
code to allow the user to manipulate the audio output by changing a state the one or more widgets to match at least one characteristic of the audio output to a corresponding characteristic of the user tinnitus; and
code to determine one or more characteristics of the user tinnitus from the state of the one or more widgets.

14. The device of claim 13 wherein each widget is representative of one of central frequency, bandwidth, volume, and tone to noise ratio of the user tinnitus.

15. The device of claim 9 wherein the code to receive input date representative of the hearing threshold of the user comprises:
code to expose the user to successive audio outputs of increasing amplitude at one or more pre-selected frequencies over a normal hearing range; and
code to receive an indication from the user at what amplitude at each frequency the user first hears the audio output.

16. The device of claim 9 wherein the device is a mobile device capable of receiving the program code from a computer system connected to the mobile device through a network.

17. A computer-readable medium comprising computer instructions, which when executed, carry out a method for treating tinnitus comprising:
receiving, by a programmed computer system, input data representative of one or more of the following characteristics of an user tinnitus: central frequency, bandwidth, volume, and tone to noise ratio of a user tinnitus;
processing, in real-time, by the programmed computer system, user tinnitus data to generate a user tinnitus profile based on the received one or more categories of user tinnitus data; and
generating, in real-time, by the programmed computer system, a notched audio output according to the user tinnitus profile.

18. The computer-readable medium of claim 17 further comprising computer instructions to provide the notched audio output to a mobile electronic device for delivery of the notched audio output to the user.

19. The computer-readable medium of claim 17 wherein the instructions for receiving comprise instructions, which when executed, carry out the following steps:
presenting to a user an interface with one or more widgets changeable by the user, each widget being representative of one or more characteristics of the user tinnitus;
generating an audio output to the user;
allowing the user to manipulate the audio output by changing a state the one or more widgets to match at least one characteristic of the audio output to a corresponding characteristic of the user tinnitus; and
determining one or more characteristics of the user tinnitus from the state of the one or more widgets.

20. The computer-readable medium of claim 17 wherein the instructions for receiving input data representative of the hearing threshold of the user comprise instructions, which when executed, carry out the following steps:
exposing the user to successive audio outputs of increasing amplitude at one or more pre-selected frequencies over a normal hearing range; and
receiving an indication from the user at what amplitude at each frequency the user first hears the audio output.
